(19) United States
(12) Patent Application Publication
(10) Pub. No.: US 2009/0259883 A1
(43) Pub. Date: Oct. 15, 2009

(54) ROBUST SYNCHRONIZATION OF DIAGNOSTIC INFORMATION AMONG POWERTRAIN CONTROL MODULES

(76) Inventors: Kenneth M. Simpson, Swartz Creek, MI (US); Hallett D. Breidenbach, West Bloomfield, MI (US); Michael E. List, Grand Blanc, MI (US); Timothy K. Sheffer, Rush, NY (US); Bradley S. McClellan, Howell, MI (US)

Correspondence Address: DELPHI TECHNOLOGIES, INC., M/C 480-410-202, PO BOX 5052, TROY, MI, 48007, US

(21) Appl. No.: 12/101,400

(22) Filed: Apr. 11, 2008

(51) Int. Cl. G06F 11/00

(52) U.S. Cl. 714/11; 714/E11.001

(57) ABSTRACT

An automotive system has a primary control module, such as an engine control module (ECM) configured for connection to a malfunction indicator lamp (MIL), and a secondary control module, such as a transmission control module (TCM), each in communication with each other over a bus. Each control module includes a respective diagnostic data status record. Each record includes a pending fault field, a confirmed fault field and an MIL control status field. An improved method for synchronizing the diagnostic data contained in the respective status records includes an extended status signal set that is used to communicate over the bus. The set includes a diagnostic testing complete signal, a fault present signal and a MIL request signal indicative of a request to illuminate the MIL. Logic in the receiving control module (ECM) interprets the extended status signal set to properly synchronize its diagnostic data status record with the TCM's, including both pending and confirmed faults.

### TECHNICAL FIELD

The invention relates generally to vehicle diagnostics and more particularly to a method of synchronizing diagnostic information among powertrain control modules.

### BACKGROUND OF THE INVENTION

Increasing awareness of the effects of vehicle exhaust emissions and the like has resulted in regulations to control these emissions. In particular, various federal and state on-board diagnostic regulations (e.g., OBDII) require that certain emission related systems on the vehicle be monitored, and that a vehicle operator be notified if the system is not functioning in a predetermined manner. Automotive vehicle electronics therefore include a programmed diagnostic data manager or similar service configured to receive reports from diagnostic algorithms/circuits concerning the operational status of various components or systems and to set/reset various standardized diagnostic trouble codes (DTC) and/or otherwise generate an alert (e.g., Malfunction Indicator Lamp—MIL). The intent of such diagnostics is to inform the operator when performance of a component and/or system has degraded to a level where emissions performance may be affected and to provide information (e.g., via the DTC) to facilitate remediation.

In one configuration, a typical automotive system may include an engine control module (ECM) provided to control the engine and a transmission control module (TCM) configured to control an automatic transmission. However, only one control module, typically the engine control module, is configured to illuminate or extinguish the MIL. Accordingly, when a control module other than the ECM wishes to illuminate (or extinguish) the MIL, one approach allows for the other control module(s) to directly request the ECM to illuminate the MIL. This request is typically made through the use of a single signal, commonly referred to as an MIL control signal (i.e., a flag where TRUE means illuminate and FALSE means extinguish). However, such an approach for controlling the MIL is inadequate in light of certain new diagnostic regulations that require maintaining the status of both so-called pending and confirmed faults. A confirmed fault will typically involve illumination of the MIL, while a pending fault is typically a fault that has not yet matured into a confirmed fault. Since the conventional MIL control approach only deals with confirmed faults, it is inadequate to communicate the status of pending faults between control modules, as would be required to meet the new, more precise diagnostic reporting requirements (i.e., in accordance with California Air Resources Board—CARB requirements).

There is therefore a need for a system and method for synchronizing diagnostic information among powertrain control modules that minimizes or eliminates one or more of the problems described above.

### SUMMARY OF THE INVENTION

One advantage of the present invention is that it allow separate control modules to more comprehensively synchronize diagnostic data between and among them. In an automotive context, the present invention allows synchronizing of diagnostic data pertaining to CARB promulgated pending and confirmed fault status.

In a system having a primary control module, such as an engine control module (ECM) configured for connection to a malfunction indicator lamp (MIL) and a secondary control module, such as a transmission control module (TCM), both in communication with each other by virtue of a communications bus, a method is provided for synchronizing diagnostic data between the primary and secondary control modules. The method includes a number of steps. The first step involves providing a first diagnostic status record associated with the primary control module wherein the first status record contains first diagnostic data. The next step involves providing a second diagnostic status record associated with the secondary control module wherein the second status record contains second diagnostic data. The status records will each include a respective pending fault status field, a confirmed fault status field, and an MIL control status field. The next step of the method involves communicating an extended signal set from the secondary control module to the primary control module. The signal set includes a fault present signal, a diagnostic testing complete signal and an MIL request signal, which are generated in accordance with the second diagnostic status record. The next step involves synchronizing, at the primary control module, the first diagnostic status record with the second diagnostic status record based on the extended signal set. In aid of this synchronizing step, the primary control module includes logic configured to interpret the signal set so as to properly and reliably extract status information, and thus perform the synchronization. In a preferred embodiment, the method achieves synchronization of CARB promulgated pending and confirmed diagnostic fault status.

A corresponding systems is also presented.

Other features, aspects and advantages of the invention will become apparent from the detailed description along with the accompanying drawings

### BRIEF DESCRIPTION OF THE DRAWINGS

The present invention will now be described by way of example, with reference to the accompanying drawings.

FIG. 1 is a simplified block diagram view of a system for robust synchronization of diagnostic information among powertrain control modules.

FIG. 2 is a flowchart showing a method for synchronizing diagnostic data.

FIG. 3 is a flowchart showing, in greater detail, the synchronizing step of FIG. 2.

### DETAILED DESCRIPTION OF THE PREFERRED EMBODIMENT

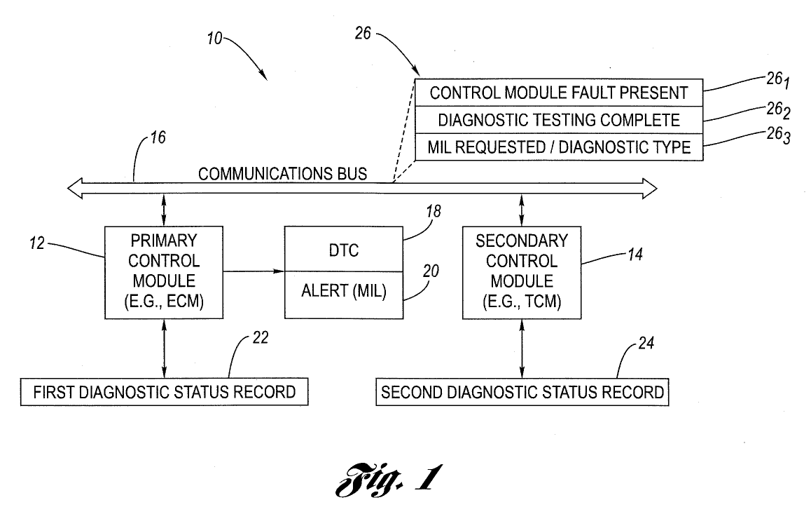

Referring now to the drawings wherein like reference numerals are used to identify identical components in the various views, FIG. 1 is a simplified block diagram view of system 10 for synchronizing diagnostic data. In this description, the system 10 is described in connection with an automotive vehicle system (not shown), although it should be understood that this is exemplary only and not limiting in nature. The system 10 includes a first or primary control module, such as an engine control module (ECM) 12, a second or secondary control module, such as a transmission control module (TCM) 14, and a communications bus 16 configured to allow communication of data therebetween. As known, the ECM 12 is configured generally to control the operation of an internal combustion engine (not shown) and the TCM 14 is configured generally to control the operation of an automatic transmission (also not shown).

Generally, the ECM 12 may include at least one microprocessor or other processing unit, associated memory devices such as read only memory (ROM) and random access memory (RAM), a timing clock, input devices for monitoring input from external analog and digital devices and controlling output devices. The ECM 12 is operable to monitor engine operating conditions and other inputs (e.g., operator inputs) using the plurality of sensors and input mechanisms, and control engine operations with the plurality of output systems and actuators, using pre-established algorithms and calibrations that integrate information from monitored conditions and inputs. The software algorithms and calibrations which are executed in the ECM 12 may generally comprise conventional strategies known to those of ordinary skill in the art. Overall, in response to the various inputs, the ECM 12 develops the necessary outputs to control the throttle valve position, fuel, spark, and other aspects, all as known in the art. The TCM 14 is also configured to include at least one microprocessor or other processing unit, associated memory devices such as read only memory (ROM) and random access memory (RAM), a timing clock, input devices for monitoring input from external analog and digital devices and controlling output devices, all in the furtherance of controlling the transmission.

In addition to the control of the engine, the ECM 12 is also configured to perform various diagnostics. As described in the Background, the ECM 12 may be configured to include a diagnostic data manager or the like, a higher level service arranged to manage the reports received from various lower level diagnostic routines/circuits and to set or reset diagnostic trouble code(s)/service codes, as well as illuminate or extinguish various alerts, all as known generally in the art. As shown in FIG. 1, the ECM 12 is configured in exemplary fashion to set or reset a diagnostic trouble code (DTC) 18 and/or generate an operator alert, such as illuminating a Malfunction Indicator Lamp (MIL) 20. It should be understood that such various lower level diagnostic monitoring/testing routines and/or circuits may be resident in both the ECM 12 or the TCM 14.

Before proceeding, however, a general overview relating to on-board diagnostic conventions will be set forth to ensure consistency in understanding the detailed description that will follow. The California Air Resources Board (CARB) has promulgated various regulations concerning automotive diagnostics, as known to those of skill in the art. Consistent with these regulations, generally, a pending fault is a fault that has been logged during the latest driving cycle in which a diagnostic monitor/test has completed and recorded a test result. Likewise, a confirmed fault is generally taken to be a fault that has matured to a point where the Malfunction Indicator Lamp (MIL) is to be illuminated. A driving cycle is an interval that begins with the application of ignition to a subject control module, continues through normal operations, removal of ignition, and power-down of the control module and ends with a return to a reset state. There are two noteworthy types of faults. One type, a so-called Type A Fault, is a fault associated with a Type A diagnostic. Type A diagnostics are emissions-related diagnostics that will result in the MIL being illuminated immediately when a first failure of such diagnostic is reported (i.e., to a supervisory diagnostic data manager service or the like). Once the MIL is illuminated, the MIL will be extinguished only after three consecutive driving cycles reporting passing results. A so-called Type B fault is a fault associated with a Type B diagnostic. Type B diagnostics are emissions-related diagnostics that will result in the MIL being illuminated when such diagnostic reports (i.e., to a supervisory diagnostic data manager service or the like) the second one of two consecutive failures occurring on consecutive driving cycles (a first failure of the Type B diagnostic having already been reported during the first driving cycle but that did not result in the MIL being illuminated). Once the MIL is illuminated, the MIL will be extinguished only after three consecutive driving cycles reporting passing results. If a failure occurs on one driving cycle and the next driving cycle does not report any result for that diagnostic (i.e., does not report either a “pass” or a “fail”), then a third driving cycle will still count as being “consecutive” if the failure re-occurs. The only way to reset the two-driving-cycle count is to have a driving cycle in which the diagnostic reports a passing result.

With this background, a better understanding of the limitations of the conventional, single signal approach described in the Background may be had with reference to Table 1 below. Simply stated, a single control signal is not capable of synchronizing pending fault status between control modules. Table 1 shows the respective status of pending and confirmed faults as stored in a primary control module (CM1) and a secondary control module (CM2) using only the single MIL control signal. For frame of reference, the pending and confirmed fault status are shown in adjacent columns, as per CARB 1968.2/ISO 15031-5. In whole, Table 1 depicts the progression for a typical Type B fault as occurring on the secondary control module (CM2), and the inability of the conventional art to properly synchronize the status in the primary control module with the correct status in the secondary control module.

With continued reference to FIG. 1, for example, where a diagnostic failure is present (“pending”) but that has not yet matured to the point where the MIL should be requested on (“confirmed”), the conventional MIL control approach fails. This is shown in the first row of Table 1 (“Key Cycle #1”). The correct status, as stored in the secondary control module, is that the “Pending Fault” status is TRUE. However, since the conventional approach has no mechanism to communicate this, the “Pending Fault” status in the primary control module remains FALSE. After a second failure in CM2 during “Key Cycle #2”, the single MIL control signal/flag is able to synchronize the Pending and Confirmed Fault status in CM1. After the diagnostic reports passing results in “Key Cycle #3”, and at the beginning of “Key Cycle #4” (per CARB regulations), the pending fault status in CM2 will be FALSE (although the MIL has not yet been cleared-this takes three consecutive passing results). However, again, the conventional, single MIL control signal/flag cannot communicate this to CM1. Accordingly, as shown in Table 1, the diagnostic status information, specifically the “pending fault” status for CM1 and CM2, remains unsynchronized for Key Cycles #4 and #5. It is not until the Key Cycle #6, when the confirmed fault is cleared, due to three consecutive passes, that the diagnostic status information for CM1 and CM2 again become synchronized.

TABLE 1
Type B Fault Under Conventional MIL Control

| | Pending | | | | | | |
|---|---|---|---|---|---|---|---|
| | Status | | CM2 | | | | |
| | (based | Confirmed | Communicate | | | | |
| | on | Status/MIL | Confirmed | CM2 | | | |
| | CARB | Status | Fault Status | Pending | | | |
| | 1968.2/ | (based on | Through | Status (This | | CM2 | CM1 |
| | ISO | CARB | Fault (“MIL | is what | CM1 | Confirmed | Confirmed |
| | 15031- | 1968.2/ISO | Control”) Flag | should be | Pending | Status/MIL | Status/MIL |
| Situation | 5) | 15031-5) | as | indicated). | Status | Status | Status |
| Failure | TRUE | FALSE (No | FALSE (No | TRUE in | FALSE | FALSE | FALSE |
| Identified by | | MIL) | MIL) | CM2, but | (this | | |
| CM2, MIL is | | | | CM1 is | should be | | |
| commanded | | | | unaware of | true) | | |
| off (KEY | | | | this | | | |
| CYCLE #1). | | | | | | | |
| Same | TRUE | TRUE (MIL | TRUE (MIL | TRUE: | TRUE | TRUE | TRUE |
| Failure | | ON) | ON) | assumed | (assumed | | |
| Identified by | | | | from the | from | | |
| CM2, | | | | Confirmed | presence of | | |
| Illuminate | | | | Status | CM2 | | |
| MIL (KEY | | | | | confirmed | | |
| CYCLE #2). | | | | | fault.) | | |
| Pass | TRUE | TRUE (MIL | TRUE (MIL | TRUE | TRUE | TRUE | TRUE |
| Identified by | | ON) | ON) | | (assumed | | |
| CM2, but | | | | | from | | |
| MIL STILL | | | | | presence of | | |
| ON (during | | | | | CM2 | | |
| first pass | | | | | confirmed | | |
| driving | | | | | fault.) | | |
| cycle) (KEY | | | | | | | |
| CYCLE #3). | | | | | | | |
| Pass | FALSE | TRUE (MIL | TRUE (MIL | FALSE | TRUE | TRUE | TRUE |
| Identified by | | ON) | ON) | | (assumed | | |
| CM2, but | | | | | from | | |
| MIL STILL | | | | | presence | | |
| ON | | | | | of | | |
| (beginning | | | | | confirmed | | |
| of next | | | | | fault and | | |
| driving | | | | | MIL ON | | |
| cycle after | | | | | flag from | | |
| first pass | | | | | CM2.) | | |
| driving | | | | | | | |
| cycle) (KEY | | | | | | | |
| CYCLE #4). | | | | | | | |
| Pass | FALSE | TRUE (MIL | TRUE (MIL | FALSE | TRUE | TRUE | TRUE |
| Identified by | | ON) | ON) | | (assumed | | |
| CM2, but | | | | | from | | |
| MIL STILL | | | | | presence | | |
| ON | | | | | of | | |
| (beginning | | | | | confirmed | | |
| of next | | | | | fault and | | |
| driving | | | | | MIL ON | | |
| cycle after | | | | | flag from | | |
| second | | | | | CM2.) | | |
| pass driving | | | | | | | |
| cycle) (KEY | | | | | | | |
| CYCLE #5). | | | | | | | |
| Pass | FALSE | TRUE (No | FALSE (No | FALSE | FALSE | TRUE | TRUE (This |
| Identified by | | MIL - Even | MIL) | | | | state is |
| CM2, MIL | | though the | | | | | assumed |
| TURNED | | MIL is | | | | | due to the |
| OFF | | extinguished | | | | | stored |
| (beginning | | the | | | | | history of |
| of next | | confirmed | | | | | the fault in |
| driving | | fault | | | | | CM1). |
| cycle after | | remains | | | | | |
| third pass | | until code | | | | | |
| driving | | clear per | | | | | |
| cycle) (KEY | | CARB | | | | | |
| CYCLE #6). | | 1968.2/ISO | | | | | |
| | | 15031-5) | | | | | |

With continued reference to FIG. 1, it should be appreciated that three primary pieces of information are required to be synchronized between any two control modules communicating diagnostic status information: (1) the pending fault status; (2) the confirmed fault status; and (3) the MIL control status. The ECM 12 has a first diagnostic status record 22, which includes at least these three pieces of diagnostic information. Likewise, the TCM 14 has a second diagnostic status record 24, which also includes at least these three pieces of diagnostic information. In one embodiment, first diagnostic status record 22, although in ECM 12, is intended to reflect the diagnostic status of the TCM 14, more particularly the status of the diagnostic routines resident in or sub-systems/circuits under the control of TCM 14. It should be understood, however, that this framework may be extensible so that a diagnostic status record may be provided for each monitored feature or diagnostic test (i.e., the extension being there would be provided a plurality of respective diagnostic status records). Other variations are possible, in accordance with one of ordinary skill in the art. While a method of synchronizing the diagnostic data in the first diagnostic status record 22 with that stored in the second diagnostic status record 24 is presented herein, the synchronizing may occur in the opposite direction, or by and between more than two control modules. In one embodiment, each of the diagnostic status records 22, 24 thus includes at least a pending fault status field (e.g., bit), a confirmed fault status field (e.g., bit) and an MIL control status field (e.g. bit).

With continued reference to FIG. 1, to accomplish the more comprehensive level of synchronization contemplated by this invention, an extended status signal set 26 is provided, which set includes a control module fault present signal 26₁, a diagnostic testing complete signal 26₂, and an MIL requested/diagnostic type signal 26₃. The fault present signal 26₁ is TRUE when the control module has identified a fault in its system. The fault may be either a pending fault or a confirmed fault. When the control module has not identified a fault, the status of the fault present signal 26₁ is FALSE. The testing complete signal 26₂ is TRUE when all of the diagnostic tests of the control module have been executed at least once and the pass (or fail) status has been recorded by the control module. Finally, the MIL requested signal 26₃, which can also be used to discern the diagnostic fault type, is TRUE only when a confirmed fault is present in the control module, thereby requiring that the MIL be illuminated during the current driving cycle. As will be seen, this extended signal set 26 of control signals, when used according to the methods described herein, provides the capability of synchronizing both pending and confirmed faults between control modules.

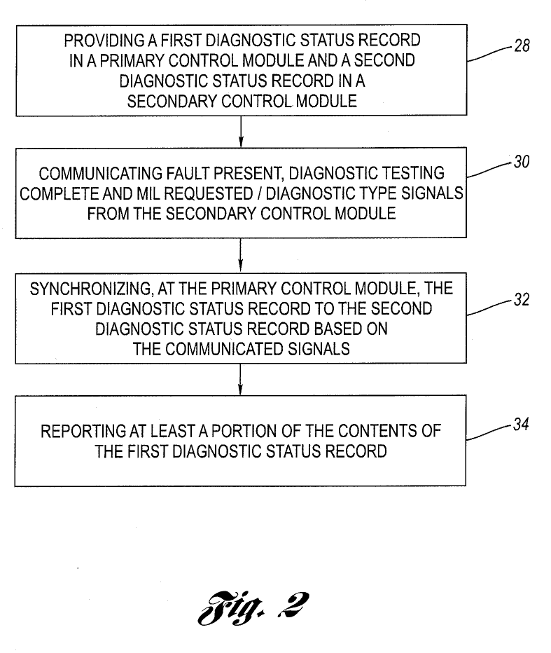

FIG. 2 is a flowchart showing, in overview fashion, a method of synchronizing diagnostic data between control modules. The method begins in step 28.

In step 28, the method involves providing a first diagnostic status record in a primary control module and a second diagnostic status record in a secondary control module. In one embodiment, the primary control module may be the control module that is connected to or is otherwise capable of illuminating/extinguishing the MIL. The method proceeds to step 30.

In step 30, the method involves communicating a fault present signal, a diagnostic testing complete signal and an MIL requested signal (i.e., the set 26) from the secondary control module to the primary control module. The generation of these signals is in accordance with the definitions for each signal as described above. These signals carry the information that the logic in the primary control module needs to properly and reliably indicate the status of both pending and confirmed fault status. The method proceeds to step 32.

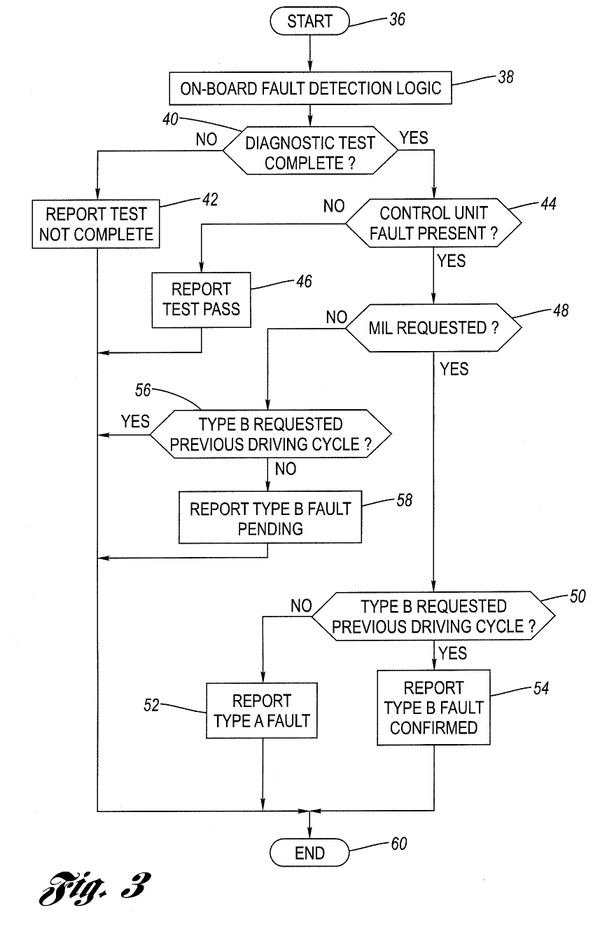

In step 32, the method involves synchronizing, at the primary control module, the diagnostic data stored in the first diagnostic status record with the data stored in the second diagnostic status record based on the communicated signal set 26. The manner in which these signals are interpreted will be described in greater detail in connection with the flowchart of FIG. 3. The method then proceeds to step 34.

In step 34, the method involves reporting at least a portion of the diagnostic data stored in the first diagnostic status record, for example, to a higher-level supervisory diagnostic data manager service or the like. Such diagnostic data may also be made available for reporting to an external device (e.g., service tool).

FIG. 3 is a flowchart showing, in greater detail, the synchronizing and reporting steps of FIG. 2. The method begins in step 36, and proceeds to step 38, which step indicates the beginning of the on-board fault detection logic. The method then proceeds to step 40.

In step 40, the primary control module that receives the signal set 26—the ECM 12 is the described embodiment—is configured to determine whether diagnostic testing in the secondary control module—the TCM—has been completed. The ECM 12 is configured to make this determination by examining the diagnostic testing complete signal 26₂, which if FALSE, causes the method to branch to step 42. In step 42, the method involves reporting (e.g., to the diagnostic data manager service) that diagnostic testing has not been completed. Then method then proceeds to step 60 (“END”). If, however, the diagnostic testing complete signal 26₂ is TRUE, then the method branches to step 44.

In step 44, the ECM 12 is configured to determine whether there is a fault present in the TCM. The ECM 12 is configured to make this determination by examining the fault present signal 26₁, which if FALSE causes the method to branch to step 46. In other words, a FALSE or NO in step 46 means that diagnostic testing has reported passing results. Accordingly, step 46 involves reporting (e.g., to a diagnostic data manager service or the like) passing results for the diagnostic testing in question. If, however, the fault present signal 26₁ is TRUE, this means that the diagnostic testing in the TCM 14 has produced a fault in some regard. The method then branches to step 48.

In step 48, the ECM 12 is configured to determine whether the MIL has been requested to be illuminated. The ECM 12 is configured to make this determination by examining the MIL request signal 26₃. If the MIL request signal 26₃ is TRUE (“YES”), then a confirmed fault can be presumed. The method branches to step 50. In step 50, the ECM 12 is configured to determine whether a Type B pending fault had been communicated to the ECM 12 from the TCM 14 in the previous driving cycle. It should be understood that if the MIL has been requested on the present driving cycle, then one of two situations must exist in the TCM 14: either (1) a first failure occurred for the present driving cycle for a Type A fault, which would result in the MIL request signal 26₃ being set (TRUE); or (2) a second consecutive failure occurred for the present driving cycle for a Type B fault, which would also result in the MIL request signal 26₃ being set (TRUE). To enable such logic to be performed, the ECM 12 is configured to keep track of whether a Type B pending fault was requested in the previous driving cycle. The ECM 12 may have a Type B fault counter or like facility to keep track of the needed history. If the ECM 12 determines that no Type B pending fault was requested by the TCM 14 in the previous driving cycle (“NO” branch in the flowchart), then the method branches to step 52. In step 52, the ECM 12 reports a Type A confirmed fault. However, if the ECM 12 determines that a Type B was in-fact requested in the previous driving cycle (“YES” branch in the flowchart), then the method branches to step 54. In step 54, the ECM 12 reports a Type B confirmed fault. In either case, the method proceeds to step 60 (“END”).

On the other hand, when the answer in step 48 is “NO”, the method branches to step 56. In step 56, the ECM 12 is configured to determine whether a Type B pending fault was requested in the previous driving cycle. As noted above, to enable performance of this step, the ECM 12 is configured to keep track of previously requested Type B pending fault requests from the TCM 14 using conventional approaches, such as described above. It should be appreciated that if a Type B pending fault request was made on the previous driving cycle, and the fault present signal 26₁ for current driving cycle indicates a fault present but yet no MIL request signal 26₃ has been asserted (i.e., TRUE), then the fault that is present must be for another, different Type B diagnostic, which would not accrue to the two-occurrence requirement needed to request MIL illumination. To circumvent continued reporting of a Type B pending fault (albeit originating with a different, failed Type B diagnostic), the method inhibits reporting of this for the present driving cycle. This is shown in the flowchart as a bypass. Thus, if the answer in step 56 is “YES”, then the method branches directly to step 60 (“END”). On the other hand, if the ECM 12 determines that no Type B pending fault was requested in the previous driving cycle (“NO” branch in the flowchart), then the method simply branches to step 58. In step 58, the method involves the ECM 12 reporting a Type B pending fault, which in this case is the first time for the Type B pending fault. This selective inhibiting of Type B pending fault reporting allows the diagnostic data manager service or like facility in the ECM 12, that is responsible for receiving and managing such reports, to continue executing its normal logic. In this embodiment, there is no need to modify the data manager to accommodate duplicative Type B pending fault reports. Finally, it should be understood that the diagnostic status record 22 is updated in accordance with the conclusions reached by the logic as described above for FIG. 3 (and which are reported).

Table 2 shows how the present invention provides for the accurate and reliable synchronization of diagnostic status information (i.e., pending, confirmed) between control modules for a Type B fault. Again, the primary control module CM1 corresponds to the ECM 12 in the described embodiment while the secondary control module CM2 corresponds to the TCM 14. The progression of events, on a per key-cycle basis, is the same as in Table 1. However, the pending and confirmed fault status in CM1 is perfectly synchronized with the pending and confirmed fault status in CM2.

TABLE 2
Type B Fault.

| | | | Communications Interface | | | | | |
|---|---|---|---|---|---|---|---|---|
| | Control Module | | (Invention) | | | | | |
| | #2 | | | | MIL | | | |
| | CM2 | | | | Requested | | | |
| | Pending | | | | Flag (this | | | |
| | Status: | CM2 | Diagnostic | | may also be | | | |
| | This is | Confirmed | Testing | Fault | used in | Control Module #1 | | |
| | what | Status/ | Complete | Present | determining | CM1 | CM1 | |
| | should be | MIL | (signal | (signal | fault type- | Pending | Confirmed | CM1 MIL |
| Situation | indicated | Status | 26₂). | 26₁). | signal 26₃). | Status | Status | Status |
| Failure | TRUE | FALSE | TRUE | TRUE | FALSE | TRUE | FALSE | FALSE |
| Identified by | | | | | | | | |
| CM2, MIL is | | | | | | | | |
| commanded | | | | | | | | |
| off (Key | | | | | | | | |
| Cycle #1). | | | | | | | | |
| Same | TRUE | TRUE | TRUE | TRUE | TRUE | TRUE | TRUE | TRUE |
| Failure | | | | | | | | |
| Identified by | | | | | | | | |
| CM2, | | | | | | | | |
| Illuminate | | | | | | | | |
| MIL (Key | | | | | | | | |
| Cycle #2). | | | | | | | | |
| Pass | TRUE | TRUE | TRUE | FALSE | TRUE | TRUE | TRUE | TRUE |
| Identified by | | | | | | | | |
| CM2, but | | | | | | | | |
| MIL STILL | | | | | | | | |
| ON (during | | | | | | | | |
| first pass | | | | | | | | |
| driving | | | | | | | | |
| cycle) (Key | | | | | | | | |
| Cycle #3). | | | | | | | | |
| Pass | FALSE | TRUE | FALSE | FALSE | TRUE | FALSE | TRUE | TRUE |
| Identified by | | | | | | | | |
| CM2, but | | | | | | | | |
| MIL STILL | | | | | | | | |
| ON | | | | | | | | |
| (beginning | | | | | | | | |
| of next | | | | | | | | |
| driving cycle | | | | | | | | |
| prior to | | | | | | | | |
| completion | | | | | | | | |
| of | | | | | | | | |
| diagnostic | | | | | | | | |
| evaluations | | | | | | | | |
| after first | | | | | | | | |
| pass driving | | | | | | | | |
| cycle) (Key | | | | | | | | |
| Cycle #4). | | | | | | | | |
| Pass | FALSE | TRUE | FALSE | FALSE | TRUE | FALSE | TRUE | TRUE |
| Identified by | | | | | | | | |
| CM2, but | | | | | | | | |
| MIL STILL | | | | | | | | |
| ON | | | | | | | | |
| (beginning | | | | | | | | |
| of next | | | | | | | | |
| driving cycle | | | | | | | | |
| after second | | | | | | | | |
| pass driving | | | | | | | | |
| cycle) (Key | | | | | | | | |
| Cycle #5). | | | | | | | | |
| Pass | FALSE | TRUE | FALSE | FALSE | FALSE | FALSE | TRUE | FALSE |
| Identified by | | | | | | | (This | |
| CM2, MIL | | | | | | | state is | |
| TURNED | | | | | | | assumed | |
| OFF | | | | | | | due to the | |
| (beginning | | | | | | | stored | |
| of next | | | | | | | history of | |
| driving cycle | | | | | | | the fault in | |
| after third | | | | | | | CM1). | |
| pass driving | | | | | | | | |
| cycle) (Key | | | | | | | | |
| Cycle #6). | | | | | | | | |

Table 3 shows how the present invention provides for the accurate and reliable synchronization of diagnostic status information (i.e., pending, confirmed) between control modules for a Type A fault. Again, the primary control module CM1 corresponds to the ECM 12 in the described embodiment while the secondary control module CM2 corresponds to the TCM 14. The progression of events, on a per key-cycle basis, is the same as in Table 1, with the exception that only one failure of a Type A diagnostic is sufficient to illuminate the MIL. The pending and confirmed fault status in CM1 is perfectly synchronized with the pending and confirmed fault status in CM2.

TABLE 3
Type A Fault.

| | | | Communications Interface | | | | | |
|---|---|---|---|---|---|---|---|---|
| | | | (Invention) | | | | | |
| | | | | | MIL | | | |
| | Control Module | | | | Requested | | | |
| | #2 | | | | Flag (this | | | |
| | | CM2 | Diagnostic | | may also be | | | |
| | | Confirmed | Testing | Fault | used in | Control Module #1 | | |
| | CM2 | Status/ | Complete | Present | determining | CM1 | CM1 | |
| | Pending | MIL | (signal | (signal | fault type- | Pending | Confirmed | CM1 MIL |
| Situation | Status: | Status | 26₂). | 26₁). | signal 26₃). | Status | Status | Status |
| Failure | TRUE | TRUE | TRUE | TRUE | TRUE | TRUE | TRUE | TRUE |
| Identified by | | | | | | | | |
| CM2, MIL is | | | | | | | | |
| commanded | | | | | | | | |
| on (Key | | | | | | | | |
| Cycle #1). | | | | | | | | |
| Pass | TRUE | TRUE | TRUE | FALSE | TRUE | TRUE | TRUE | TRUE |
| Identified by | | | | | | | | |
| CM2, but | | | | | | | | |
| MIL STILL | | | | | | | | |
| ON (during | | | | | | | | |
| first pass | | | | | | | | |
| driving | | | | | | | | |
| cycle) (Key | | | | | | | | |
| Cycle #2). | | | | | | | | |
| Pass | FALSE | TRUE | FALSE | FALSE | TRUE | FALSE | TRUE | TRUE |
| Identified by | | | | | | | | |
| CM2, but | | | | | | | | |
| MIL STILL | | | | | | | | |
| ON | | | | | | | | |
| (beginning | | | | | | | | |
| of next | | | | | | | | |
| driving cycle | | | | | | | | |
| prior to | | | | | | | | |
| completion | | | | | | | | |
| of | | | | | | | | |
| diagnostic | | | | | | | | |
| evaluations | | | | | | | | |
| after first | | | | | | | | |
| pass driving | | | | | | | | |
| cycle) (Key | | | | | | | | |
| Cycle #3). | | | | | | | | |
| Pass | FALSE | TRUE | FALSE | FALSE | TRUE | FALSE | TRUE | TRUE |
| Identified by | | | | | | | | |
| CM2, but | | | | | | | | |
| MIL STILL | | | | | | | | |
| ON | | | | | | | | |
| (beginning | | | | | | | | |
| of next | | | | | | | | |
| driving cycle | | | | | | | | |
| after second | | | | | | | | |
| pass driving | | | | | | | | |
| cycle) (Key | | | | | | | | |
| Cycle #4). | | | | | | | | |
| Pass | FALSE | TRUE | FALSE | FALSE | FALSE | FALSE | TRUE | FALSE |
| Identified by | | | | | | | (This | |
| CM2, MIL | | | | | | | state is | |
| TURNED | | | | | | | assumed | |
| OFF | | | | | | | due to the | |
| (beginning | | | | | | | stored | |
| of next | | | | | | | history of | |
| driving cycle | | | | | | | the fault in | |
| after third | | | | | | | CM1). | |
| pass driving | | | | | | | | |
| cycle) (Key | | | | | | | | |
| Cycle #5). | | | | | | | | |

The present invention provides an extended signal set 26 available for use between control modules that allows robust synchronization of diagnostic data, as described above.

It should be understood that the ECM 12 and the TCM 14 as described above include conventional processing apparatus known in the art, capable of executing pre-programmed instructions stored in an associated memory, all performing in accordance with the functionality described herein. That is, it is contemplated that the processes described herein will be programmed in a preferred embodiment, with the resulting software code being stored in the associated memory. Implementation of the invention, in software, in view of the foregoing enabling description, would require no more than routine application of programming skills by one of ordinary skill in the art. Such control modules may further be of the type having both ROM, RAM, a combination of non-volatile and volatile (modifiable) memory so that the software can be stored and yet allow storage and processing of dynamically produced data and/or signals.

While particular embodiments of the invention have been shown and described, numerous variations and alternate embodiments will occur to those skilled in the art. Accordingly, it is intended that the invention be limited only in terms of the appended claims.

1. In a system having a primary control module configured for connection to a malfunction indicator lamp (MIL) and a secondary control module in communication with the primary control module, a method for synchronizing diagnostic data between the primary and secondary control modules, comprising the steps of:
providing a first diagnostic status record associated with the primary control module, the first status record containing first diagnostic data;
providing a second diagnostic status record associated with the secondary control module, the second status record containing second diagnostic data;
communicating a status signal set, which includes a fault present signal, a diagnostic testing complete signal and an MIL request signal, from the secondary control module to the primary control module, the signal set being generated in accordance with the second diagnostic status record; and
synchronizing, at the primary control module, the first diagnostic status record with the second diagnostic status record based on the communicated signal set.

2. The method of claim 1 wherein said step of providing a first diagnostic status record includes the sub-step of:
defining the first diagnostic status record to include a pending fault status field, a confirmed fault status field and a MIL control status field.

3. The method of claim 1 wherein said step of providing a second diagnostic status record includes the sub-step of:
defining the second diagnostic status record to include a pending fault status field, a confirmed fault status field and a MIL control status field.

4. The method of claim 3 further including the steps of:
resetting the diagnostic testing complete signal as a logic false;
commencing performance of predetermined diagnostic testing at the secondary control module;
setting the diagnostic testing complete signal as a logic true when the secondary control module has completed the predetermined diagnostic testing and a passing/failure status has been recorded.

5. The method of claim 4 wherein said system includes a Type A fault associated with failure of a Type A diagnostic and a Type B fault associated with failure of a Type B diagnostic, said method further including the step of:
resetting the fault present signal to a default, logic false;
setting the fault present signal to a logic true when a fault has been identified by the secondary control module.

6. The method of claim 5 wherein said step of setting the fault present signal includes the sub-steps of:
setting the pending fault status field of the second status record to a logic true when the identified fault is due to one of (1) a first failure of the Type B diagnostic and (2) a first failure of a Type A diagnostic;
setting the confirmed fault status field of the second status record to a logic true when the identified fault is due to one of (1) a second failure of the Type B diagnostic on a second consecutive driving cycle and (2) a first failure of a Type A diagnostic; and
setting the MIL control status field of the second status record to a logic true when the confirmed fault status field is first set to logic true.

7. The method of claim 6 further including the step of:
resetting the MIL request signal to a logic false;
setting the MIL request signal as a logic true when one of a plurality of predefined conditions are satisfied including a first predefined condition comprising a first failure during a first driving cycle of a Type A diagnostic and a second predefined condition comprising a second consecutive failure during consecutive driving cycles of a Type B diagnostic.

8. The method of claim 7 wherein said synchronizing step includes the substep of:
evaluating the MIL request signal when the diagnostic testing complete signal and the fault present signal are both logic true.

9. The method of claim 8 further including the step of resetting a Type B pending fault counter, and wherein said step of evaluating the MIL request signal includes the substeps of:
determining a Type B pending fault status associated with the secondary control module when the MIL request signal is false and the Type B pending fault counter is reset, and thereafter setting the Type B pending fault counter.

10. The method of claim 9 further including the step of:
reporting the Type B pending fault.

11. The method of claim 9 wherein said step of evaluating the MIL request signal includes the further substep of:
inhibiting the reporting of subsequent Type B pending faults when the MIL request signal is false and the Type B pending fault counter is set.

12. The method of claim 9 wherein said step of evaluating the MIL request signal includes the substep of:
determining a Type A confirmed fault status associated with the secondary control module when the MIL request signal is true and the Type B pending fault counter is reset.

13. The method of claim 9 wherein said step of evaluating the MIL request signal includes the substep of:
determining a Type B confirmed fault status associated with the secondary control module when the MIL request signal is true and the Type B pending fault counter is set.

14. The method of claim 13 further including the step of:
reporting the Type B confirmed fault.

15. The method of claim 14 further including the step of:
updating the first diagnostic status record.
